(19) United States
(12) Patent Application Publication
(10) Pub. No.: US 2021/0299622 A1
(43) Pub. Date: Sep. 30, 2021

(54) Solid-Liquid Mixer

(71) Applicant: Jeffrey S. Jones, Westerville, OH (US)

(72) Inventor: Jeffrey S. Jones, Westerville, OH (US)

(21) Appl. No.: 17/213,463

(22) Filed: Mar. 26, 2021

Related U.S. Application Data
(60) Provisional application No. 63/000,042, filed on Mar. 26, 2020.

(51) Int. Cl. B01F 11/00; B01F 3/12; B01F 3/14; B01F 15/00

(52) U.S. Cl. CPC B01F 11/0017; B01F 3/1221; B01F 2215/0014; B01F 15/00441; B01F 15/00538; B01F 3/14

(57) ABSTRACT

A device for agitating non-homogenous combinations of liquids and solids, such as peanut butter, other nut butters, yogurt, salad dressings and mixed drinks. The device mixes products in their containers without insertion into the product, eliminating the mess associated with stirring. A receptacle has a cylindrical chamber configured for receiving a container of product and is pivotably mounted along a single axis that is disposed near a first end of the receptacle. A rotatable body has a first shaft inserted into an elongated channel in a second end of the receptacle. A second shaft is inserted into a bearing and has a second pivot axis spaced radially from the first pivot axis. A prime mover drives the rotatable shaft in rotation and reciprocates the receptacle about the single axis. The elongated channel is substantially parallel with the single axis and the first shaft has a first pivot axis.

### CROSS-REFERENCES TO RELATED APPLICATIONS

This application claims the benefit of U.S. Provisional Application No. 63/000,042 filed Mar. 26, 2020. The above prior application is hereby incorporated by reference.

### STATEMENT REGARDING FEDERALLY-SPONSORED RESEARCH AND DEVELOPMENT

(Not Applicable)

### THE NAMES OF THE PARTIES TO A JOINT RESEARCH AGREEMENT

(Not Applicable)

### REFERENCE TO AN APPENDIX

(Not Applicable)

### BACKGROUND OF THE INVENTION

The invention relates generally to devices used to mechanically agitate, and more specifically to devices used to agitate in order to mix separate components within a container.

Natural peanut and other nut butters are healthier alternatives to commercial products that are processed, such as being stabilized by the addition of hydrogenated or partially hydrogenated oils. Many nut butters are produced in natural and highly processed form. Unfortunately, between the time natural nut butters leave their production facilities and are purchased by consumers, they are more prone to separation into layers of oil and densely packed solids than the less healthy, more highly processed, forms of nut butters. This separation of components requires the consumer to re-mix the product back to a palatable and spreadable consistency. The stirring process is typically accomplished by opening the product container and using a knife, small spatula or other device to manually mix the butter by stirring. This process is time-consuming, requires significant strength and almost always results in spilled nut oil, which is difficult to remove from countertops, the outsides of nut butter jars and clothing.

There is a need for an inexpensive, convenient and easy-to-use means of mixing natural nut butters, and other separated components, to result in a better consistency.

### BRIEF SUMMARY OF THE INVENTION

Disclosed herein is an agitating device comprising a receptacle having a chamber configured for receiving a container of product to be agitated. The receptacle pivotably mounts along a single axis that is disposed nearer a first end of the receptacle than a second, opposite end of the receptacle. A drive system is drivingly linked to the receptacle near one of the ends, and the drive system is configured to drive the receptacle reciprocatingly about the single axis.

In some embodiments, the drive system comprises a rotatable body with a first shaft having a first pivot axis and a second shaft having a second pivot axis that is spaced radially from the first pivot axis. In some embodiments, the drive system is drivingly linked to the receptacle near the first end and the first rotating shaft is inserted into an elongated channel in the second end of the receptacle. In some embodiments, the elongated channel is substantially parallel with the single axis.

In some embodiments, the drive system comprises a prime mover with a rotatable shaft, a belt drivingly linked to the rotatable shaft and extending around the rotatable body, and the rotatable body's first shaft extending into the elongated channel and the second shaft extending into a bearing. In some embodiments, the drive system comprises a prime mover with a rotatable shaft coaxial with the rotatable body's second shaft and the rotatable body's first shaft extending into the elongated channel.

Disclosed herein is an agitating device comprising a receptacle having a substantially cylindrical chamber configured for receiving a container of product to be agitated. The receptacle is pivotably mounted along a single axis that is disposed nearer a first end of the receptacle than a second, opposite end of the receptacle. A rotatable body has a first shaft inserted into an elongated channel in the second end of the receptacle. The elongated channel is substantially parallel with the single axis and the first shaft has a first pivot axis. A second shaft is inserted into a bearing, wherein the second shaft has a second pivot axis that is spaced radially from the first pivot axis. A prime mover with a rotatable shaft has a belt drivingly linked to the rotatable shaft and extending around the rotatable body. Upon rotation of the rotatable shaft, the belt drives the rotatable body in rotation and reciprocates the receptacle about the single axis.

Some embodiments have a base to which the receptacle and the prime mover are mounted. Some embodiments have a spacer configured to insert between the container of product and the receptacle.

The agitating device accomplishes an effective re-mixing of nut butters and other non-homogenous liquids, pastes, semi-liquids and other states without opening the original product container. The disclosed apparatus effectively eliminates the mess associated with a step that is necessary prior to the use of natural nut butters and other non-homogenous liquids, pastes and other components of varying thickness. The apparatus works by the user inserting a container of nut butter or other product to be mixed into a cup, and then activating the device. The operation of the apparatus causes the product to be mixed by the movement of the cup, and, by extension, the product, thereby avoiding the mess and the possible contamination of the product that accompanies the conventional process of inserting a mixing tool into the separated nut butter and oil. With the invention, the user simply removes the jar of product from the device after mixing, opens the jar and enjoys the product.

While other devices have been proposed for a mixing purpose, they differ in design from the disclosed apparatus in that they: (a) rely on the insertion of a “paddle” or other component into the product to be mixed, which results in contamination and spillage; (b) require that the product be transferred to another container, which results additional products that need to be cleaned and possibly spillage; (c) are manually powered; or (d) rely on some form of circular, rotational or spinning vortex motion to accomplish the mixing.

In order for a nut butter or other separated product to be mixed, the design of the apparatus described herein relies on oscillating linear motion about a pivot axis that is vertically offset from the product's center of gravity. This establishes multiple competing wave forms, which results in effective mixing. Spinning motions are effective for mixing separated fluids of similar viscosities or distributing a small amount of a suspended solid in a large volume of liquid, but neither of these describes nut butter separation. This apparatus operates on the theory that lateral reciprocating vibration more effectively imparts kinetic energy into large dense particles, such as nut solids, causing them to mix more rapidly and thoroughly with a small volume of much lower relative viscosity fluid, such as nut oil.

The design of the disclosed apparatus also favors a broader coverage of wave patterns formed within the product being mixed so as to accomplish a faster and more thorough mixing. To this end, the product to be mixed is supported at a point in which the portions of the product container above and below the support point are different and their heights do not share a small common multiple. As an example, in one embodiment, the support point, and thus the pivot axis of the shaking motion, for the container holding the product being mixed may be at 63.2% of the height of the container. This is from the bottom of the container, which results in the pivot axis being 36.8% of the height of the container from the container's top. Any similar proportion is contemplated that has more than about half of the mass of the product above or below the pivot axis and less than about half of the mass of the product on the opposite side of the pivot axis.

Some advantages of the disclosed apparatus include that it effectively mixes nut butters and other non-homogenous liquids, pastes and other components of varying thickness. When well-mixed nut butters are stored in a refrigerator, the product may not separate even after several weeks of storage. Thus, the product may only need to be stirred once. The apparatus effectively eliminates the considerable mess and inconvenience of other mixing methods. The simple design allows for inexpensive manufacture and a low price point. The device is relatively small and self-contained in one embodiment that may be approximately 9″×8″×5″ in overall size.

A preferred embodiment may include a functional and decorative cover to enclose the moving parts of the apparatus for safety and to provide an attractive appearance. The disclosed embodiment does not include an external cover.

### BRIEF DESCRIPTION OF THE SEVERAL VIEWS OF THE DRAWINGS

FIG. 1 is a view in perspective illustrating an embodiment of the present invention.

FIG. 2 is a view in perspective illustrating a base of the FIG. 1 embodiment.

FIG. 3 is a view in perspective illustrating a cup of the FIG. 1 embodiment.

FIG. 4 is a view in perspective illustrating a pulley of the FIG. 1 embodiment.

FIG. 5 is a view in perspective illustrating the embodiment of FIG. 1.

FIG. 6 is a section view in perspective illustrating the embodiment of FIG. 5, viewed through the line 6-6.

FIG. 7 is a side section view illustrating the embodiment of FIG. 5 viewed through the line 6-6.

FIG. 8 is a view in perspective illustrating some components of the embodiment of FIG. 5.

FIG. 9 is a partial section view in perspective illustrating an embodiment of the invention.

FIG. 10 is a section view in perspective illustrating the embodiment of FIG. 9 through the line 10-10.

FIG. 11 is a view in perspective illustrating the cup.

FIG. 12 is a view in perspective illustrating the raceway.

FIG. 13 is a view in perspective illustrating the support arm mounts.

FIG. 14 is a view in perspective illustrating the cup support arms.

FIG. 15 is a view in perspective illustrating a sizing insert.

FIG. 16 is a view in perspective illustrating the motor mounts.

FIG. 17 is a view in perspective illustrating alternative pulleys.

FIG. 18 is a view in perspective illustrating the embodiment of FIG. 1 with the cup removed for visibility of other components.

FIG. 19 is a side section view illustrating an alternative embodiment of the invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Provisional Application No. 63/000,042, filed Mar. 26, 2020, is hereby incorporated in this application by reference.

The apparatus 10 may be an electrically-powered appliance designed for in-home use. The size is contemplated to be approximately 9″×8″×5″ (height×length×width), but this is only exemplary and not limiting. Such a size is convenient for use on a working surface, such as a countertop, a conventional table, a workbench or any other surface upon which an appliance may be used by a human operator. Nevertheless, a larger or smaller size may be constructed, as will become apparent to a person of ordinary skill from the disclosure herein, based on preference and/or the materials being mixed.

One embodiment of the apparatus is shown having a base 12 that may rest upon a working surface. The base 12 serves as a foundation or framework to integrate other separate components into a unitary apparatus, such as by supporting numerous structures in relative position to one another. The base may be an oblong rounded triangular plastic component that may measure roughly 6″ wide×8″ long by 1½″ thick. This size is not critical.

In another embodiment, the base may be made of heavier construction, such as metal, to provide greater stability and durability.

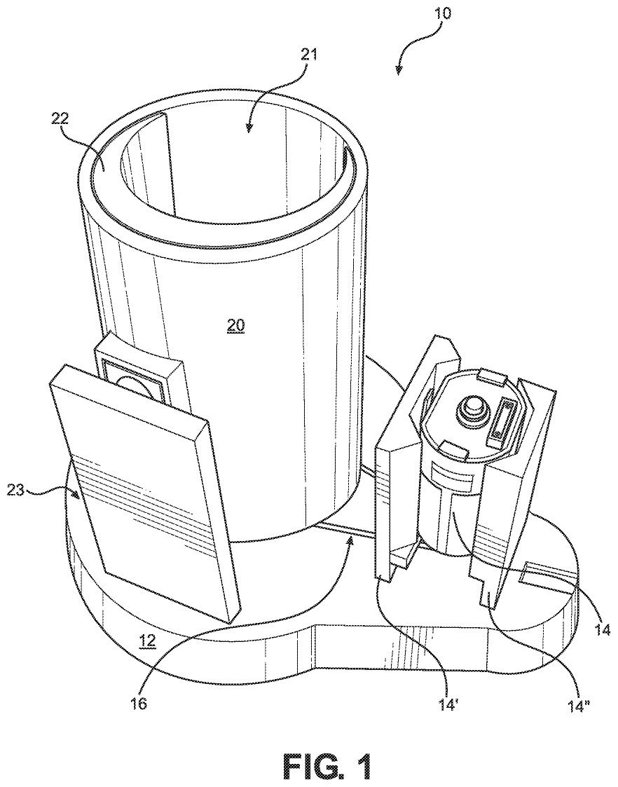

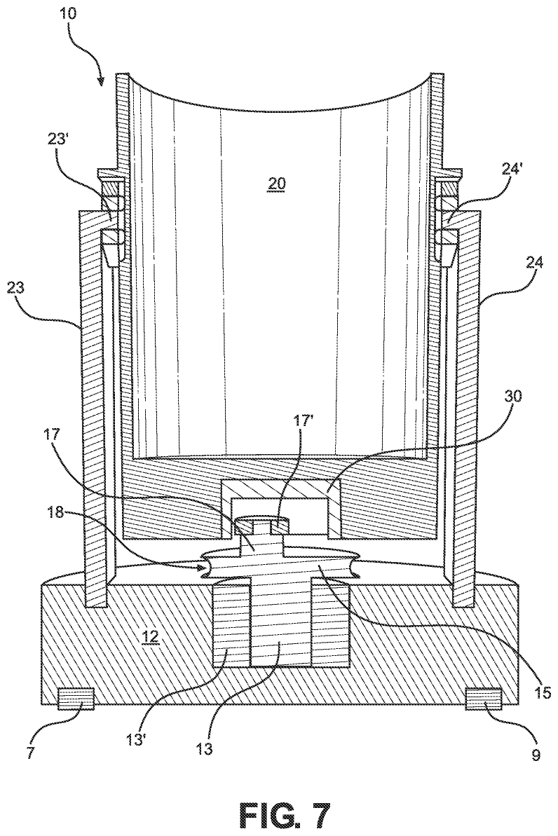

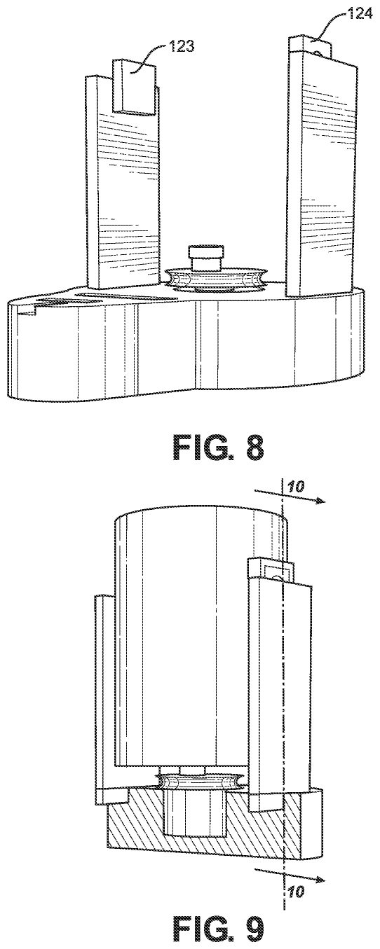

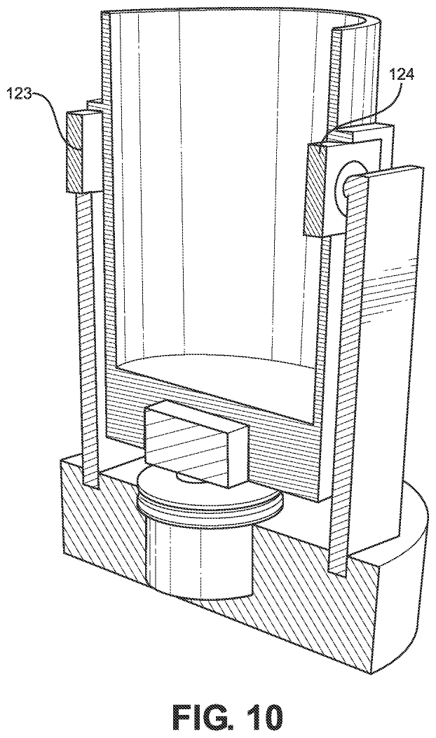

The base 12 provides mounting points for the suction cups, motor mounts, and drive pulley bearings, as described herein. The base 12 also provides device stability, such as when suction cup feet (not visible) rest on, and maintain the base 12 in contact with, a working surface. Such feet may be attached to the bottom of the base 12 and may extend toward the working surface 8 (FIG. 1). In one embodiment shown in FIG. 7, the feet 7 and 9 are flat-bottomed and made of hollow soft rubber and extend into cavities formed in the bottom of the base 12.

In another embodiment, six soft rubber suction cup feet may be attached, for example with hot glue, to the base 12 to provide device stability during use. The feet may include an internal hard plastic component which causes the sides and top of the feet to retain their shape. When the apparatus 10 is activated, suction may be applied to the feet, evacuating a hollow core and causing the bottom of the feet to deform slightly, creating suction between the feet and the supporting surface (table, counter, etc.) for stability during use. At the end of the operational cycle the suction may be released to allow for easy movement of the device.

An adjustable holding cup 20 receives and secures one of many various product containers for nut butters, such as a conventional peanut butter jar/receptacle. The cup 20 has a cylindrical sidewall 26 joined at one end to a floor 28, thereby forming a chamber 21 into which the product container may be inserted and held during use of the apparatus 10. The cup 20 includes a thick base with a recess in the center of the exterior face of the cup floor 28, which securely holds the raceway 30. The cup 20 provides secure retention of the product to be stirred during device operation and connects to the sizing inserts, raceway and support arm mounts. A lid may also be added to retain the product container in the chamber during use.

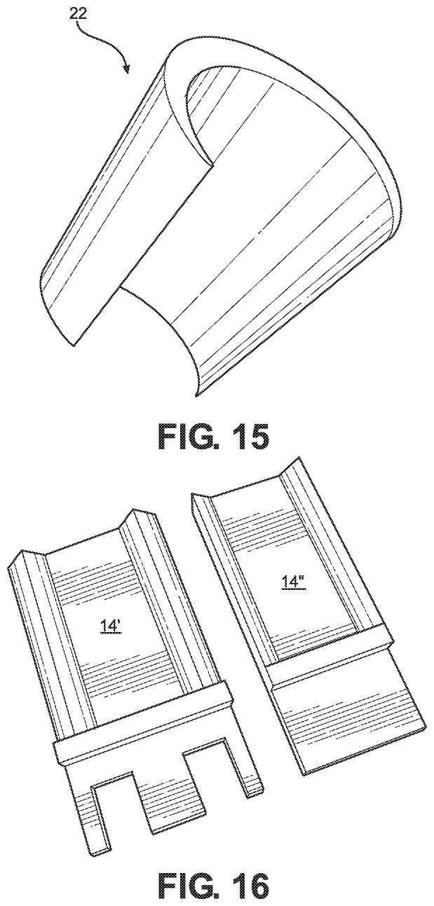

To accommodate various sizes of product containers, some embodiments utilize a cup designed to firmly hold the largest desired container. If a container is smaller than the larges desired container, one of various plastic sizing inserts (e.g., insert 22, FIGS. 1 and 15) may be used to effectively reduce the size of the cup chamber 21 as appropriate. The sizing inserts insert between the smaller container and the sidewall 26 to enable the cup 20 to hold various sizes of product containers tightly enough that reciprocation of the cup does not cause the product container to move relative to the cup sufficiently that any damage occurs. In another embodiment an adjustable cup accommodates product containers of a wide variety of sizes and the sizing inserts are not required.

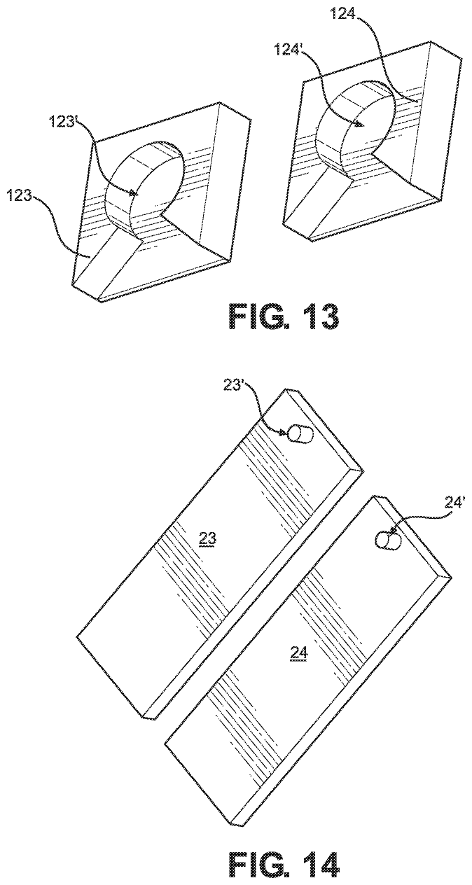

The cup 20 is mounted to the base 12 by cup support arms 23 and 24 having lower ends that extend into the retention sockets 133 in the base 12 and attach firmly, such as by adhesive, welding or fasteners. The support arms 23 and 24 have axles, which may be circular cylindrical protrusions 23′ and 24′ (FIG. 7) mounted on the upper ends of the support arms, that are perpendicular to the planes of the support arms 23 and 24, respectively. The protrusions 23′ and 24′ are retained in corresponding voids 123′ and 124′ (FIG. 13) formed in the support arm mounts 123 and 124. The protrusions 23′ and 24′ are coaxial to form an axis of rotation of the cup 20. The support arm mounts 123 and 124 are preferably made of a flexible, vibration-dampening material, which may be rubber, polyurethane or another elastic material, in order to minimize the amount of mechanical energy transferred to the support arms 23 and 24 from the rapidly moving cup 20, as will be described below. One embodiment employs a non-toxic RoHS-compliant thermoplastic polyurethane for the support arm mounts 123 and 124. The support arm mounts 123 and 124 preferably dampen the vibrations of the cup 20 from being transmitted to the support arms, thus improving the durability of the support arms.

The support arms 23 and 24 are vertical members (in the orientation of FIG. 1) that attach to the base 12 and hold the cup 20 through the support arm bearings and the support arm mounts 123 and 124 at a proper height above the base 12. This permits movement of the cup 20 during use and allows routing of a drive belt 16 from the motor pulley to the drive pulley 18. The protrusions 23′ and 24′ insert into the support arm mounts 123 and 124 in an operable position and connect to the cup 20 to the support arms 23 and 24.

In an operable position, the support arm mounts 123 and 124 are disposed in retention sockets, which may be the cradles 123″ and 124″, respectively, that are mounted or formed integrally on opposite sides of the cup 20. In an embodiment with a cup and a product container that are 4¾ inches tall, these retention sockets are located on the cup 20 in a position that disposes the axis of rotation of the cup 20 about 3 inches (63.2% of product container height) from the bottom of the product container and 1¾ inches (36.8% of product container height) from the top of the product container. In some embodiments, the cup has a static support arm mount height corresponding to the most common product container size. In other embodiments an adjustable support arm mount height preserves the desired relative height of the support arm mounts.

Some of the surfaces of the mechanism that are in contact and move relative to one another may have low-friction bearings, which may be low friction coatings, to reduce the friction between the surfaces. The coated surfaces may include the cup support arms 23 and 24, the support arm mounts 123 and 124, the protrusions 23′ and 24′ and the support arm mounts 123 and 124.

The protrusions 23′ and 24′ are located on the support arms 23 and 24, respectively, to support the cup 20 at a position above the center of gravity of the product container that will be held in the cup, as explained further herein. The support arms 23 and 24 thus support the cup 20 in an operable position at a point vertically higher than the center of the product's center of gravity when the product container is retained in the chamber 21 of the cup 20. Thus, the axis of rotation of the cup 20 is vertically offset from the center of gravity of the product when in an operable position.

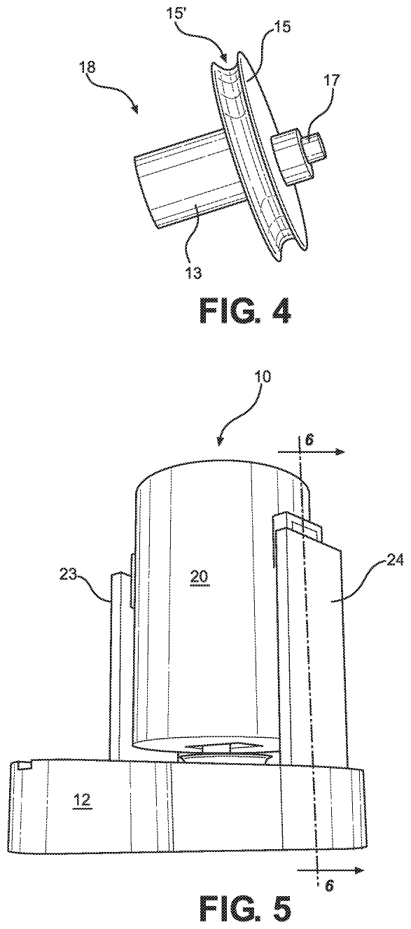

The drive mechanism of the apparatus 10 is shown in FIGS. 4 and 7, among others. The drive mechanism includes an offset-axis drive pulley 18 that has a lower shaft 13, an upper shaft 17 and a central disk 15 interposed between the lower shaft 13 and upper shaft 17. The lower shaft 13 and the central disk 15 are preferably coaxial. Thus, upon rotation about the axis of the lower shaft 13, the axis of the central disk 15 does not move appreciably radially relative to the axis of the lower shaft 13. The axis of the upper shaft 17, however, is intentionally offset radially from being coaxial with the lower shaft 13 and the central disk 15. Therefore, upon rotation about the axis of the lower shaft 13, the upper shaft 17 moves in a circular path and revolves around the axis of the lower shaft 13 at a distance spaced radially from the axis of the lower shaft. The radial distance that the axis of the upper shaft 17 is spaced from the axis of the lower shaft 13 and the central disk 15 remains the same at all times during operation of the embodiment of the apparatus 10.

The lower shaft 13 of the drive pulley 18 is supported by a drive pulley bearing 13′ that interfaces with the base 12. The upper (offset) shaft 17 supports the bearing 17′, which interfaces the drive pulley 18 with the raceway 30 while reducing friction. The drive pulley 18 is driven by the drive belt 16 which engages the central disk 15 of the drive pulley 18 in a conventional manner. The drive pulley 18 thus connects to the drive pulley bearing 13′, the raceway bearing 30, and the drive belt 16. The drive belt 16 drivingly links the motor pulley with the drive pulley 18. In one embodiment a flexible rubber drive belt 16 is used that forms a circular loop about three inches in diameter, but any adaptation to the appropriate drive belt will be understood by the person of ordinary skill from the description herein. The drive pulley central disk 15 may have a 3/16″ diameter half-round groove 15′ (see FIG. 4) around its peripheral edge that guides the drive belt 16 during operation. One embodiment uses a drive pulley 18 with a central disk 15 having outside diameter of 1⅞″ which corresponds to a diameter of 1 11/16″ for the drive belt bearing surface.

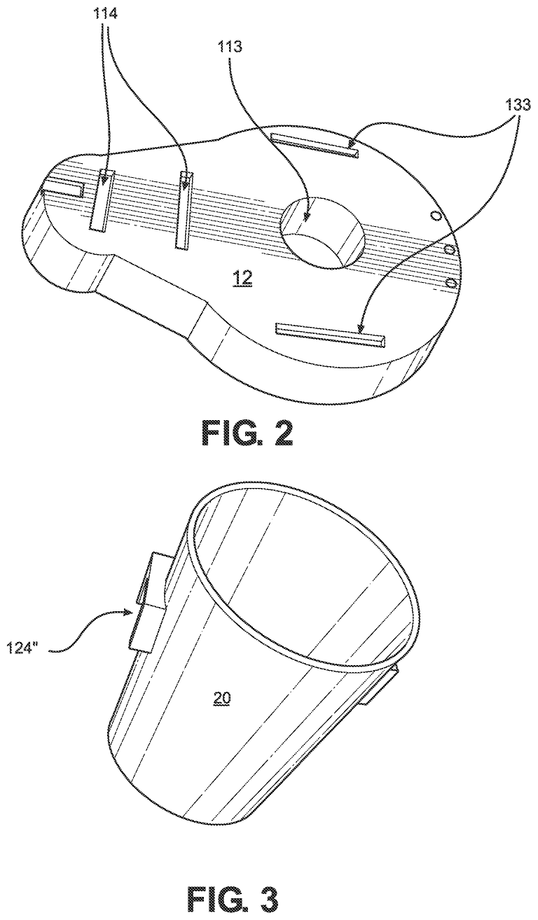

The lower shaft 13 extends into a cavity 113 (FIG. 2) formed in the base 12, and may have a low friction bearing 13′ interposed between the lower shaft 13 and the sidewalls of the base 12 that define the cavity 113. This bearing 13′ reduces friction between the drive pulley 18 and the base 12. The drive pulley bearing 13′ may attach directly to the base 12 and provide support for the drive pulley 18 while reducing the friction between the rotating drive pulley 18 and the base 12. In one embodiment, a pair (stacked) of ¾″ (ID)×1¾″ (OD)×½″ (W) bearings may be utilized.

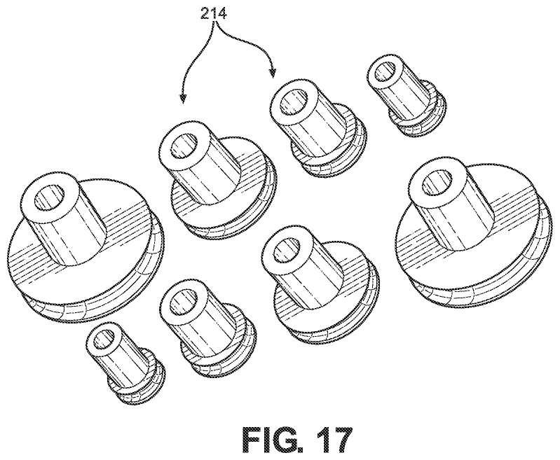

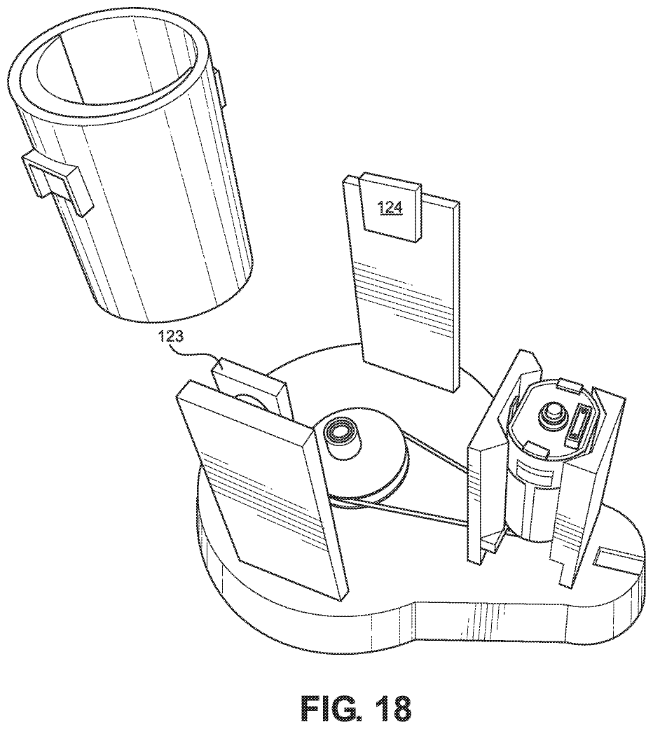

The drive pulley 18 may be rotated about the axis of the lower shaft 13 in a conventional manner by the drive belt 16 (FIGS. 1 and 18). The belt 16 extends in the groove 15′ of the central disk 15, and transfers power from a conventional motor pulley (not visible) mounted on a conventional driveshaft (not visible) of the motor 14. A plurality of differently sized motor pulleys 214 are shown in FIG. 17, and these pulleys 214 are contemplated to modify the speed at which the pulley 18 is driven by exchanging one of the pulleys 214 for the motor pulley on the motor's 14 driveshaft. The pulleys 214 may have various drive diameters: for example from 7 mm to 20 mm in diameter. The motor 14 transfers rotary motion to the drive belt 16, which then drives the drive pulley 18 in rotation. In some embodiments the motor pulley has an optimal drive diameter that is constant, but a variable-diameter pulley, as well as a variable-speed transmission, is also contemplated.

The motor 14 may be an electric motor, pneumatic motor or any other rotary prime mover. In some embodiments, a single-speed 2.5 amp 110 VAC 9750 rpm motor is used. The motor 14 is mounted to the base 12 by motor mounts 14′ and 14″ (FIGS. 1 and 16), which insert into slots 114 (FIG. 2) formed in the base 12 and attach firmly, such as by adhesive, welding or fasteners to hold the motor in a proper orientation and at a proper height above the base. The motor mounts are vertical members (in the orientation of FIG. 1) that are inserted into the base and hold the motor 14 at a proper height above the base 12. The motor mount 14′ that is closer to the center of the base includes a slot to allow the passage of the drive belt 16 between the motor pulley and the drive pulley 18.

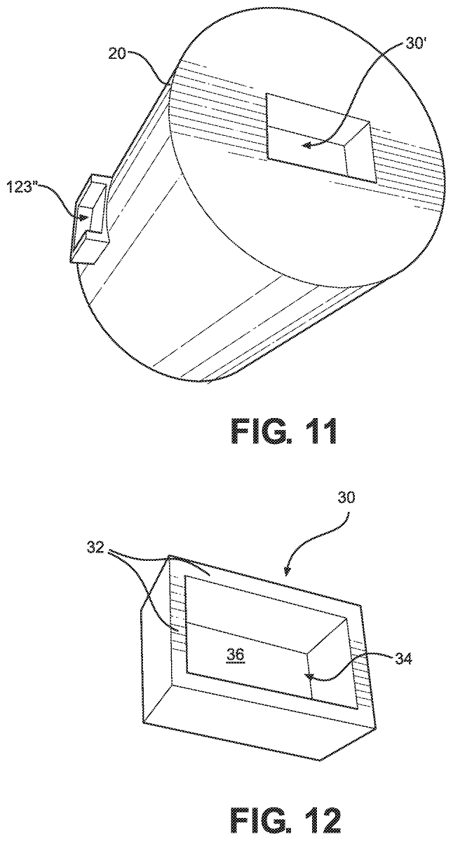

Upon actuation of the motor 14, the motor pulley drives the drive belt 16, which rotates the drive pulley 18 about the lower shaft 13, thereby revolving the upper shaft 17, which is inserted into a raceway 30, in a circular path about the axis of the lower shaft 13. The raceway 30 (FIG. 12) is a shock-absorbing insert that is disposed in the void 30′ (FIG. 11) in the bottom of the cup 20 when the cup is in an operable position, as shown in FIG. 1. The raceway 30 has sidewalls 32 that connect on ends with one another and on edges with a floor 36 to define a chamber 34 into which the upper shaft 17 is disposed in an operable position (see FIG. 7).

The raceway 30 is an interface between the cup 20 and, via the bearing 17′, the drive pulley 18. The raceway 30 is a bearing that provides a friction-reducing interface between the cup 20 and the offset upper shaft 17 of the drive pulley 18. It is contemplated that the raceway 30 may be made of a flexible material to dampen the striking of the raceway bearing with the inner sides of the raceway. Thus, the raceway is preferably a shock-dampening material, such as rubber or polyurethane, and preferably a non-toxic RoHS-compliant thermoplastic polyurethane. It is further contemplated that the friction-reducing bearing 17′ may reduce the friction between the upper shaft 17 and the raceway 30. When driven by the drive belt 16 the drive pulley 18 guides the raceway bearing 17′ in a circular, or an approximately circular, path. Due to the shape of the raceway 30, this circular raceway bearing motion is converted into lateral back-and-forth motion of the raceway, and, therefore, the cup 20 in which the raceway is inserted and attached. One embodiment has a ¼″ (Inner Diameter)×⅝″ (Outer Diameter)×¼″ (Wide) raceway bearing 17′.

The raceway 30 has a specifically designed shape that causes the raceway bearing 17′ to move without substantial resistance along one dimension (fore-aft) of its circular path that is contained within a plane preferably parallel to the drive belt 16. This raceway shape is elongated, and preferably rectangular. Alternatively, the raceway may be oval or a rectangle with rounded corners. Resistance to movement of the raceway bearing 17′ along the second (lateral) dimension results in the raceway being moved in a lateral back-and-forth motion. The raceway 30 is firmly attached to the cup as an insert into the cup floor 28, and thus the cup 20 moves about the pivot axis as the bearing 17′ moves the raceway 30.

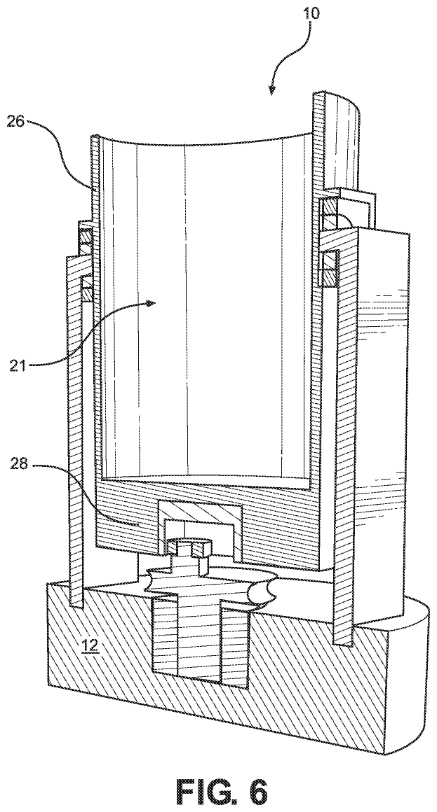

FIGS. 5 and 6 are shown from the same perspective, and FIG. 6 is a cross-sectional view of the structure of FIG. 5 through the line 6-6 about halfway across (laterally) the support arms 23 and 24. FIG. 7 is an enlarged, head-on view of the embodiment of FIG. 6, and is helpful to the explanation of the drive mechanism. As shown in FIG. 7, the lower shaft 13 is inserted into the base 12 with the bearing 13′ in position to reduce friction. The central disk 15 is rotated by the drive belt 16 (not visible in FIG. 7) about the shared axis of the central disk 15 and lower shaft 13. The offset upper shaft 17, which is inserted in the raceway 30 that is inserted in the lower end of the cup 20, has a bearing 17′ that rotates with little resistance on the upper shaft 17. The bearing 17′ may be a roller bearing. As the upper shaft 17 revolves in a circular path about the axis of the lower shaft 13, the outer edge of the bearing 17′ follows a circular path, and is in contact with the inside of the raceway chamber 34. Thus, the upper shaft 17 drives the cup 20 as the bearing 17′ seats against and displaces the raceway 30. In a preferred embodiment, the circular path that the outer edge of the bearing 17′ on the upper shaft 17 follows is no longer than the total length of the chamber 34, but is wider than the total width of the chamber 34. When this circular path is centered on the chamber 34, as shown in FIG. 7, and does not exceed the length of the chamber 34 but exceeds the width of the chamber 34, the moving pulley 18 thus drives the cup 20 in a back-and-forth motion. This is the configuration of the embodiment of at least FIG. 1 when the rotary motion of the pulley 18 causes revolution of the upper shaft 17 in a circular path about the axis of the lower shaft 13, and when the upper shaft 17 is in the elongated raceway chamber 34. In these circumstances, the bottom of the cup 20 is displaced in lateral movement about the axis of rotation of the cup, which is coaxial with the protrusions 23′ and 24′. The circular movement of the upper shaft 17 causes the reciprocating (back-and-forth) movement of the lower end of the cup 20 along an arcuate path due to the parallel alignment of the axis of rotation of the cup 20, which is along a line through the centers of the circular protrusions 23′ and 24′, with the length of the raceway chamber 34.

This reciprocating movement of the cup 20 is sufficient to mix the material that has been placed in a container disposed in the cup's chamber 21. The container with the material to be mixed is preferably positioned with the center of gravity of the material to be mixed offset vertically from the axis of rotation of the cup 20. The offset of the center of gravity is substantial, meaning more than 5%.

It is contemplated to use a counterweight to reduce vibration of the reciprocating movement of the cup 20, which vibration may otherwise be transmitted through the base 12 to a work surface upon which the base rests. In one embodiment, the drive pulley 18 may include a counterweight to reduce overall device vibration of the apparatus 10 during use while not inhibiting movement of the cup 20. The embodiments shown do not employ a counterweight, but such a counterweight will be understood by the person having ordinary skill from the disclosure herein.

As noted above, there may be one or more sizing inserts 22 placed in the chamber 21 of the cup 20 to occupy space between the outer surface of the product container and the inner surface of the cup sidewall 26 that defines the chamber 21. An insert 22 may be a plastic component shaped like the void formed between the sidewall 26 and any product container. The insert 22 effectively changes the volume of the cup 20 by occupying space between the cup sidewall 26 and the exterior of the product container. An external cover may also extend over most of the working structures to protect users from the motor 14, drive pulley 18, drive belt 16 and other moving structures. This is not shown in the embodiment disclosed.

In operation, a user places a product container, such as a glass, plastic or any other peanut butter jar or other receptacle, in the chamber 21 of the cup 20. If the fit is relatively tight, the insertion is completed. If the fit is loose, an appropriate sizing insert 22 is inserted between the jar and the cup sidewall 26. The insert 22 may offset a cylindrical jar's axis from the axis of the cylindrical cup 20, but because of the reciprocating movement of the cup 20 this does not lead to any substantial disadvantages.

Once the product container is fixed in the cup 20, the motor 14 is actuated, which drives the drive belt 16. This causes rotation of the drive pulley 18, which causes the upper shaft 17 to revolve around the axis of rotation of the lower shaft 13. This causes movement of the lower end of the cup 20 in reciprocating motion about the pivot axis formed along an axis of the protrusions 23′ and 24′. The rotary speed of the motor 14, along with the relative diameters of the pulley 18 and the motor pulley, determine the reciprocating speed (i.e., the number of cycles of reciprocation per unit time) of the cup 20. A desirable range of revolutions per minute of the motor 14 is 9,000 to 20,000 rpm, which desirably results in cup cycles in the range of 1,000 to 2,500 cycles of reciprocation per minute. Of course, this can be varied, as will be understood by a person having ordinary skill. After a sufficient period of vibrating the cup 20, the motor 14 is disengaged and the product container is removed from the chamber 21. The product within the product container may be enjoyed.

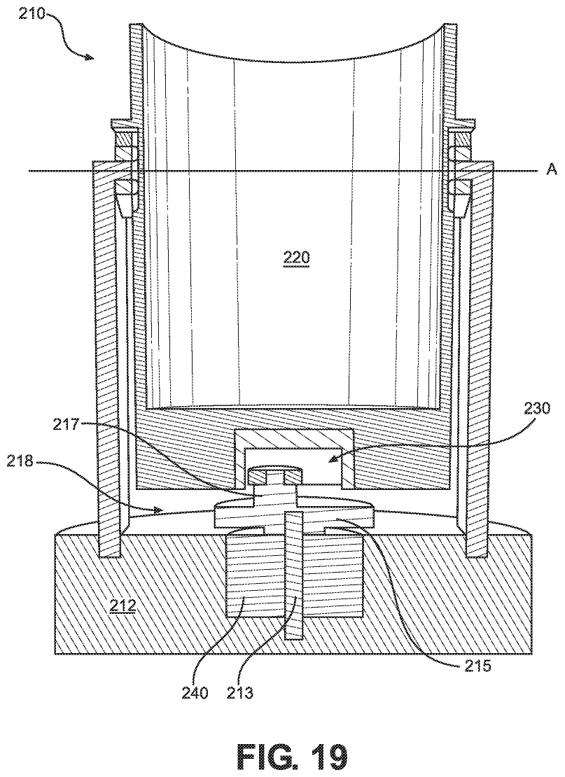

In an alternative embodiment, shown in FIG. 19, a cup 220 is pivotably mounted to the base 212 along the axis, A formed near the upper end of the cup 220 in the orientation of FIG. 19. A motor 240 may be disposed in the base 212. The motor 240 has a driveshaft 213 that drivingly mounts to the drive disk 218 and forms a lower shaft. The driveshaft 213 is radially offset from the upper shaft 217 that extends from the drive disk 218 into the elongated channel 230 in the lower end of the cup 220. Upon actuation of the motor 240, the driveshaft 213 rotates, thereby rotating the drive disk 218, which causes the upper shaft 217 that is inserted in the elongated channel 230 to revolve around the axis of the driveshaft 213 and reciprocate the cup 220 about the single pivot axis, A.

This detailed description in connection with the drawings is intended principally as a description of the presently preferred embodiments of the invention, and is not intended to represent the only form in which the present invention may be constructed or utilized. The description sets forth the designs, functions, means and methods of implementing the invention in connection with the illustrated embodiments. It is to be understood, however, that the same or equivalent functions and features may be accomplished by different embodiments that are also intended to be encompassed within the spirit and scope of the invention, and that various modifications may be adopted without departing from the invention or scope of the following claims.

1. An agitating device comprising:
(a) a receptacle having a chamber configured for receiving a container of product to be agitated, the receptacle pivotably mounted along a single axis that is disposed nearer a first end of the receptacle than a second, opposite end of the receptacle; and
(b) a drive system drivingly linked to the receptacle near one of the ends, the drive system configured to drive the receptacle in reciprocation about the single axis.

2. The agitating device in accordance with claim 1, wherein the drive system further comprises a rotatable body with
(a) a first shaft having a first pivot axis; and
(b) a second shaft having a second pivot axis that is spaced radially from the first pivot axis.

3. The agitating device in accordance with claim 2, wherein:
(a) the drive system is drivingly linked to the receptacle near the first end; and
(b) the first rotating shaft is inserted into an elongated channel in the second end of the receptacle.

4. The agitating device in accordance with claim 3, wherein the elongated channel is substantially parallel with the single axis.

5. The agitating device in accordance with claim 4, further comprising:
(a) a prime mover with a rotatable shaft;
(b) a belt drivingly linked to the rotatable shaft and extending around the rotatable body; and
(c) the rotatable body's first shaft extending into the elongated channel and the second shaft extending into a bearing.

6. The agitating device in accordance with claim 4, further comprising:
(a) a prime mover with a rotatable shaft coaxial with the rotatable body's second shaft; and
(b) the rotatable body's first shaft extending into the elongated channel.

7. An agitating device comprising:
(a) a receptacle having a substantially cylindrical chamber configured for receiving a container of product to be agitated, the receptacle pivotably mounted along a single axis that is disposed nearer a first end of the receptacle than a second, opposite end of the receptacle;
(b) a rotatable body with
(i) a first shaft inserted into an elongated channel in the second end of the receptacle, wherein the elongated channel is substantially parallel with the single axis and the first shaft has a first pivot axis; and
(ii) a second shaft inserted into a bearing, wherein the second shaft has a second pivot axis that is spaced radially from the first pivot axis;
(c) a prime mover with a rotatable shaft; and
(d) a belt drivingly linked to the rotatable shaft and extending around the rotatable body, wherein, upon rotation of the rotatable shaft, the belt drives the rotatable body in rotation and reciprocates the receptacle about the single axis.

8. The agitating device in accordance with claim 7, further comprising a base to which the receptacle and the prime mover are mounted.

9. The agitating device in accordance with claim 7, further comprising a spacer configured to insert between the container of product and the receptacle.
